(19) United States
(12) Patent Application Publication
(10) Pub. No.: US 2009/0033699 A1
(43) Pub. Date: Feb. 5, 2009

(54) INKJET IMAGE FORMING APPARATUS

(75) Inventor: Chun Ku HAN, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/132,065

(22) Filed: Jun. 3, 2008

(30) Foreign Application Priority Data
Aug. 3, 2007 (KR) 2007-78256

(51) Int. Cl. B41J 29/38

(52) U.S. Cl. 347/12

(57) ABSTRACT

An inkjet image forming apparatus is disclosed. A print head is provided having a plurality of head chips having nozzles arranged in at least two rows for each color. A storage unit stores position information of a head chip having a normal formed gap (which is in an integer multiple relationship having a resolution of, e.g., 9″/1200 or 10″/1200) between a first row of nozzles and a second row of nozzles of the at least two rows of nozzles, position information of a head chip having an erroneous formed gap (which is not in an integer multiple relationship having a resolution of, e.g., 8.5″/1200 or 9.5″/1200) between the first row of nozzles and the second row of nozzles, and gap information. A control unit controls the head chip having the normal formed gap according to a first mode, by which printing data of the first row of nozzles and the second row of nozzles for each line are simultaneously printed to have a basic vertical resolution, and to control the head chip having the erroneous formed gap according to a second mode, by which the printing data of the first row of nozzles and the second row of nozzles for each line are alternately printed to have a double basic vertical resolution.

### CROSS-REFERENCE TO RELATED APPLICATIONS

This application claims the benefit and priority under 35 U.S.C. § 119(a) of Korean Patent Application No. 2007-0078256, filed on Aug. 3, 2007 in the Korean Intellectual Property Office, the disclosure of which is incorporated herein by reference in its entirety.

### BACKGROUND OF THE INVENTION

1. Field of the Invention

The present general inventive concept relates to an inkjet image forming apparatus, and more particularly, to an inkjet image forming apparatus capable of minimizing deterioration of image quality by preventing line displacement, though a plurality of head chips mounted to a print head in a two-row arrangement structure including a head chip having an erroneous gap between nozzle rows.

2. Description of the Related Art

An inkjet image forming apparatus refers to an apparatus that forms an image by ejecting ink to a printing medium from an inkjet head which is spaced apart from the printing medium and reciprocatingly moves in a direction perpendicular to a conveying direction of the printing medium.

Recently, in order to increase a printing speed, a print head configured to reciprocatingly move in a width direction of a printing medium has been substituted by a print head having a plurality of head chips arranged corresponding to a width of a printing medium. An inkjet image forming apparatus including a print head having a plurality of head chips is referred to as an array type inkjet image forming apparatus. An array type inkjet image forming apparatus can print a line at a time without reciprocatingly moving an inkjet head, thereby remarkably increasing a printing speed.

In such an array type inkjet image forming apparatus, in order to increase a resolution, nozzles of head chips should be highly dense and highly integrated. To achieve this, the nozzles are arranged in a two-row structure, and an odd row of nozzles and an even row of nozzles are spaced apart from each other by a predetermined dot gap depending on a basic resolution (e.g., N dot/1200 dpi when the basic resolution is 1200 dpi). The odd row of nozzles and the even row of nozzles are controlled to eject ink to one line with a predetermined time lag therebetween.

However, a dot gap between an odd row of nozzles and an even row of nozzles may be shortened or lengthened more than a normal gap by various factors in a semiconductor process of manufacturing a head chip of a print head, which creates line displacement in an outputted image. In a case of a single line type inkjet image forming apparatus, line displacement has little influence on a whole image. However, in a case of an array type inkjet image forming apparatus which includes a plurality of head chips, line displacement caused by the respective head chips creates a problem of severe deterioration of image quality in a whole image.

### SUMMARY OF THE INVENTION

The present general inventive concept provides an inkjet image forming apparatus capable of minimizing deterioration of image quality by preventing line displacement in an outputted image, though a plurality of head chips mounted to a print head including a head chip having an erroneous gap between nozzle rows for each color.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet image forming apparatus including a print head including a plurality of head chips each having nozzles arranged in a plurality of rows such that at least two rows are associated with a single color, a storage unit to store position information of a head chip having a normal gap formed between a first row of nozzles and a second row of nozzles of the at least two rows of nozzles, position information of a head chip having an erroneous gap formed between the first row of nozzles and the second row of nozzles, and gap information of the print head, and a control unit to control the head chip having the normal gap according to a first mode such that printing data of the first row of nozzles and the second row of nozzles of each line of printing data are simultaneously printed to have a basic vertical resolution, and to control the head chip having the erroneous gap according to a second mode such that the printing data of the first row of nozzles and the second row of nozzles for each line of printing data are alternately printed to have a double basic vertical resolution.

When the gap formed between the first row of nozzles and the second row of nozzles is deviated from an integer multiple of a normal gap by ½ dot, the control unit may control the head chip according to the second mode.

The plurality of head chips may be arranged in a zigzag pattern.

The first row of nozzles and the second row of nozzles of each of the plurality of head chips may be arranged in a zigzag pattern.

The nozzles of each of the plurality of head chips may be arranged to include at least two rows for each color of cyan, magenta, yellow and black.

The foregoing and/or other aspects and utilities of the present general inventive concept may also be achieved by providing an inkjet image forming apparatus including a print head including a plurality of head chips having nozzles arranged in two rows for each of a plurality of colors, a storage unit to store position information of a head chip having a normal gap formed between a first row of nozzles and a second row of nozzles of the two rows of nozzles, position information of the head chip having an erroneous gap formed between the first row of nozzles and the second row of nozzles, and gap information of the print head, and a control unit to control the head chip having the normal gap according to a first mode such that printing data of the first row of nozzles and the second row of nozzles for each line of the printing data are simultaneously printed to have a basic vertical resolution, and to control the head chip having the erroneous gap selectively according to the first mode or according to a second mode such that the printing data of the first row of nozzles and the second row of nozzles for each line of the printing data are alternately printed to have a double basic vertical resolution, depending on the gap between the first row of nozzles and the second row of nozzles.

When the gap formed between the first row of nozzles and the second row of nozzles is in an integer multiple relationship with the normal gap, the control unit may control the head chip according to the first mode by adjusting printing timing of the first row of nozzles and the second row of nozzles.

When the gap formed between the first row of nozzles and the second row of nozzles is deviated from an integer multiple of a normal formed gap by ½ dot, the control unit may control the head chip according to the second mode.

The nozzles of each of the plurality of head chips may be arranged to include two rows for each color of cyan, magenta, yellow and black.

The foregoing and/or other aspects and utilities of the present general inventive concept may also be achieved by providing an inkjet image forming device including a plurality of printing medium conveying parts to convey a printing medium, a print head including a plurality of head chips each having a plurality of rows of nozzles to print an image on the printing medium, and a control unit to receive from an external device position information of a head chip of the print head having a normal gap formed between two adjacent rows of at least one of the plurality of head chips and of a head chip of the print head having an erroneous gap formed between the two adjacent rows of at least one of the plurality of head chips, and to control the head chip having the normal formed gap and the head chip having the erroneous formed gap to perform a printing operation in a first mode for the head chip having the normal formed gap and in a second mode for the head chip having the erroneous formed gap by adjusting the printing timing of the two adjacent rows of nozzles.

The first mode may be full mode printing and the second mode may be half mode printing.

In the printing operation of the second mode each of the two adjacent rows of nozzles may be printed for a time substantially equal to one-half of a time for printing for each of the two adjacent rows printed in the printing operation of the first mode.

The foregoing and/or other aspects and utilities of the present general inventive concept may also be achieved by providing a method to control an inkjet image forming apparatus having a print head having a plurality of head chips, the method including storing position information of the plurality of head chips, controlling at least one head chip which includes a normal gap formed between adjacent rows of nozzles of the at least one head chip to print printing data in the adjacent rows of nozzles simultaneously for a first time duration, and controlling at least one head chip which includes an erroneous gap formed between adjacent rows of nozzles of the at least one head chip to print printing data in the adjacent rows of nozzles such that a first of the adjacent rows of nozzles is controlled to print printing data for a second time duration equal to one-half the first time duration and a second of the adjacent rows of nozzles is controlled to print printing data for the second time duration but not simultaneously with the printing of the printing data by the first of the adjacent rows of nozzles.

The erroneous gap may be formed between the adjacent rows of nozzles such that the gap deviates by approximately ±0.5 dot from a normal formed gap.

The foregoing and/or other aspects and utilities of the present general inventive concept may also be achieved by providing an image forming apparatus, including a print head having a plurality of head chips each having a plurality of rows each having a plurality of nozzles, and a control unit to control the print head to selectively use in a printing operation the rows of each head chip according to a gap formed between adjacent rows.

One row of the adjacent rows may be used to print in a full mode printing operation.

The other one row of the adjacent rows may be used to print in a half mode printing operation.

The gap formed between the adjacent rows may be an erroneous gap.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, of which:

FIG. 1 is a view schematically illustrating an inkjet image forming apparatus according to the present general inventive concept;

FIG. 2 is a plan view illustrating a portion of a print head of the inkjet image forming apparatus depicted in FIG. 1;

FIG. 3 is a view illustrating nozzle rows of one color in one of the head chips of the portion of the print head depicted in FIG. 2;

FIG. 4 is a view illustrating head chips of the print head depicted in FIG. 2, which have an erroneous gap formed between an odd row of nozzles and an even row of nozzles;

FIG. 5 is a view illustrating printing compensation timing for every head chip depending on a gap formed between an odd row of nozzles and an even row of nozzles;

FIG. 6 is a view illustrating a result of performing a printing operation according to a first mode and a second mode with respect to a head chip which has an erroneous gap formed between an odd row of nozzles and an even row of nozzles (4.5 dot/1200 dpi);

FIG. 7 is a view illustrating a result of performing a printing operation according to a first mode and a second mode with respect to a head chip which has a normal gap formed between an odd row of nozzles and an even row of nozzles (5 dot/1200 dpi);

FIG. 8 is a view illustrating a result of performing a printing operation according to a first mode and a second mode with respect to a head chip which has an erroneous gap formed between an odd row of nozzles and an even row of nozzles (5.5 dot/1200 dpi);

FIG. 9 is a view illustrating dot positions when performing a printing operation according to a first mode with respect to head chips having a normal formed gap and head chips having an erroneous formed gap; and

FIG. 10 is a view illustrating dot positions when performing a printing operation according to a first mode with respect to head chips having a normal formed gap and performing a printing operation according to a second mode with respect to head chips having an erroneous formed gap.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

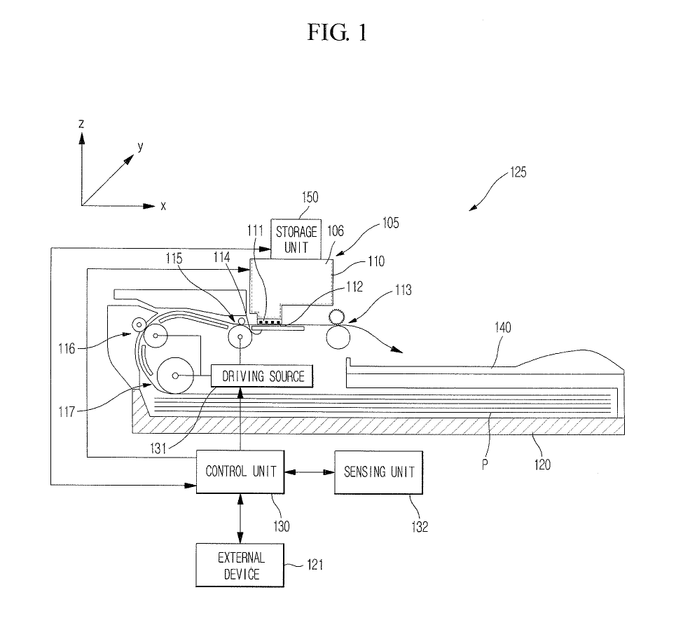

FIG. 1 is a view schematically illustrating an inkjet image forming apparatus according to the present general inventive concept. Referring to FIG. 1, an inkjet image forming apparatus 125 includes a paper feeding cassette 120, a print head unit 105 having an ink cartridge 106 with a housing 110, a supporting member 114 provided to oppose the print head unit 105, a sensing unit 132 to sense whether nozzles of a nozzle unit 112 malfunction, printing medium conveying parts 117, 116, 115 and 113 to convey a printing medium P in a first direction (x-direction), and a loading part 140 on which the discharged printing medium P is loaded. The inkjet image forming apparatus may further include a control unit 130 to communicate with the sensing unit 132 and to control operation of the aforementioned components of the inkjet image forming apparatus 125.

The printing medium P is contained in the paper feeding cassette 120. The printing medium P contained in the paper feeding cassette 120 is conveyed to the loading part 140 via a print head 111 by the printing medium conveying parts 117, 116, 115 and 113. In this embodiment, the loading part 140 refers to a part, onto which the image-formed printing medium P is discharged and loaded, such as a discharge tray.

The printing medium conveying parts 117, 116, 115 and 113 serve to convey the printing medium P contained in the paper feeding cassette 120 along a predetermined route through the inkjet image forming apparatus 125. In this embodiment, the printing medium conveying parts 117, 116, 115 and 113 are configured as a pickup roller 117, auxiliary rollers 116, a feeding roller 115 and a discharge roller 113, respectively. The printing medium conveying parts 117, 116, 115 and 113 are driven by a driving source 131 such as a motor, and provide a conveying force to convey the printing medium P. The operation of the driving source 131 is controlled by the control unit 130.

The pickup roller 117 is mounted to a portion of the paper feeding cassette 120, and picks up the printing medium P contained in the paper feeding cassette 120, sheet by sheet. The feeding roller 115 is mounted at an upstream side of the print head 111, and conveys the printing medium P drawn out of the paper feeding cassette 120 by the pickup roller 117 to the print head 111. A pair of auxiliary rollers 116 may be mounted between the pickup roller 117 and the feeding roller 115 to convey the printing medium P. The discharge roller 113 is mounted at a downstream side of the print head 111, and discharges the printed printing medium P outside of the inkjet image forming apparatus. The printing medium P discharged from the inkjet image forming apparatus is loaded on the loading part 140.

The supporting member 114 is provided below the print head 111 so as to maintain a predetermined gap between the nozzle unit 112 and the printing medium P, and supports a back surface of the conveyed printing medium P.

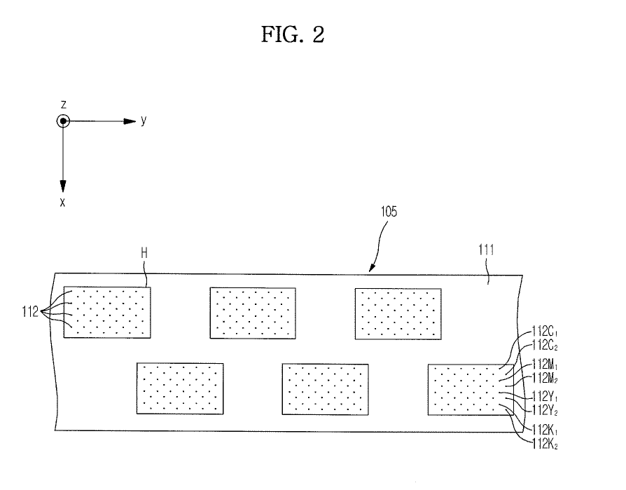

Position information of head chips H (referring to FIG. 2) of the print head 111 which have an erroneous gap, as described below in greater detail, between two nozzle rows, position information of head chips H which have a normal gap and gap information of the respective head chips H are stored in a storage unit 150 provided at the print head 111. The above position information may be transmitted to the storage unit 150 of the inkjet image forming apparatus 125 by the control unit 130 when the print head 111 is mounted in the inkjet image forming apparatus 125. The control unit 130 controls operation of the respective components of the inkjet image forming apparatus 125 according to the position information of the head chips H and the gap information of the respective head chips stored in the storage unit 150. The position information may be detected by the sensing unit 132 and/or provided to the control unit 130 from an external device 121, for example, a computer, a server (via an internet connection, or not), or a data entry device (such as a keyboard, a touch screen display, command buttons, etc.) disposed on the inkjet image forming apparatus 125.

In operation, the print head unit 105 ejects ink onto the printing medium P to print an image. As described above, in an embodiment, the print head unit 105 includes the ink cartridge 106 having the housing 110, such that the aforementioned print head 111 is provided at a portion of the housing 110, and the aforementioned nozzle unit 112 is provided at the print head 111. The feeding roller 115 is rotatably mounted at an upstream side of the nozzle unit 112, and the discharge roller 113 is rotatably mounted at a downstream side of the nozzle unit 112.

The inkjet image forming apparatus may further include a driving unit, which may be a driving circuit (not illustrated), to provide an ejection force to eject an ink droplet. The driving unit may separately drive the nozzles of the nozzle unit 112. The driving unit generates bubbles in printer ink by use of a heater to provide an ejection force to an ink droplet to eject the ink droplet by an expansive force of the bubbles. The driver means to perform the ejecting operation of the respective nozzles provided at the print head 111 may be controlled by the control unit 130.

FIG. 2 is a plan view illustrating a portion of the print head 111 depicted in FIG. 1. Referring to FIGS. 1 and 2, the print head 111 is mounted in a second direction (y-direction) with respect to the printing medium P conveyed in the first direction (x-direction). The print head 111 uses thermal energy as an ink ejecting power source, and may be manufactured to have a high resolution through a semiconductor manufacturing processes of etching, deposition, sputtering, etc. The print head 111 includes the nozzle unit 112 which ejects ink onto the conveyed printing medium P, which passes in close proximity to the print head 111, to form an image. The nozzle unit 112 may have a length equivalent to or greater than a width of the printing medium P.

As in the embodiment illustrated in FIG. 2, the print head 111 may be mounted and include a plurality of head chips H, each of which has nozzles 112C, 112M, 112Y and 112K arranged in a plurality of columns and rows, where nozzles 112C eject cyan colored ink, nozzles 112M eject magenta colored ink, nozzles 112Y eject yellow colored ink and nozzles 112K eject black colored ink. Each of the head chips H may also include a corresponding driving circuit (not illustrated) to drive the nozzles of each nozzle unit 112 of each head chip H individually, or in groups.

As illustrated in the embodiment of FIG. 2, a plurality of head chips H may be arranged in a longitudinal direction of the print head 111. If a plurality of head chips H are arranged in a single line, a gap between nozzles at a boundary formed between adjacent head chips H, i.e., a gap formed between a nozzle of one head chip H and a nozzle of the other head chip H, may be larger than a gap between nozzles in the same head chip H, which may create a problem such that ink cannot be ejected onto a certain region of the printing medium P. In such a case, a plurality of head chips H are arranged in a zigzag, or offset, pattern.

In order to increase a resolution in the second direction (y-direction), the nozzle rows of each head chip H, which eject ink of the same color, i.e., the nozzle rows 112C1 and 112C2, the nozzle rows 112M1 and 112M2, the nozzle rows 112Y1 and 112Y2 and the nozzle rows 112K1 and 112K2, may be respectively arranged in a zigzag pattern. If the nozzle rows are arranged as above, ink dots from the nozzles of one nozzle row are ejected between ink dots from the nozzles of the other nozzle row, thereby increasing a resolution in the second direction (y-direction) of the image printed on the printing medium P.

For convenience of explanation, a print head 111 having four head chips H will be described as follows.

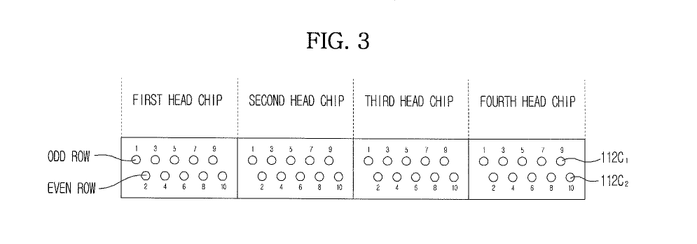

As illustrated in FIG. 3, each of the head chips H of the print head 111 has a structure such that the nozzles are arranged in two rows. A first row of nozzles and a second row of nozzles are arranged in a zigzag pattern. In this embodiment, the first row of nozzles is defined by an odd row 1, 3, 5, 7 and 9, and the second row of nozzles is defined by an even row 2, 4, 6, 8 and 10. For example, the nozzles for cyan (C), magenta (M), yellow (Y) and black (K) may be respectively arranged in two rows, where nozzles for each of the respective colors (C), (M), (Y) and (K) may be disposed on a separate respective head chip H of the print head 111.

In some cases, an error may occur in manufacturing the head chips H such that a gap formed between the odd row of nozzles and the even row of nozzles is beyond a predetermined tolerance.

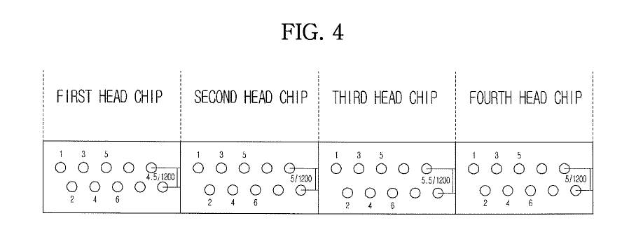

For example, as illustrated in FIG. 4, a manufacturing error may occur to cause an erroneous gap, such that a first gap formed between an odd row of nozzles and an even row of nozzles in the second and fourth head chips H of the print head 111 is within a predetermined tolerance (that is, the first gap and the resolution are in an integer multiple relationship with each other, e.g., 5 dot/1200 dpi), but a second gap, which is an erroneous gap, is formed between the odd row of nozzles and the even row of nozzles in the first and third head chips H such that the erroneous gap which is formed is beyond the predetermined tolerance (that is, the erroneous gap and the resolution are not in an integer multiple relationship with each other, e.g., 4.5 dot/1200 dpi or 5.5 dot/1200 dpi).

In such a case, if the printing operation is performed in the same manner as a conventional printing operation by use of the above head chips H having the erroneous gap, deterioration of image quality due to line displacement may occur.

In order to prevent line displacement and minimize deterioration of image quality, the head chips H having a normal gap are controlled according to a first mode, by which printing data of the odd row of nozzles of the print chips H and the even row of nozzles of the print chips H are simultaneously printed to have a basic vertical resolution, and the head chips H having an erroneous gap are controlled according to a second mode, by which printing data of the odd row of nozzles and printing data of the even row of nozzles are alternately printed to have a double basic vertical resolution.

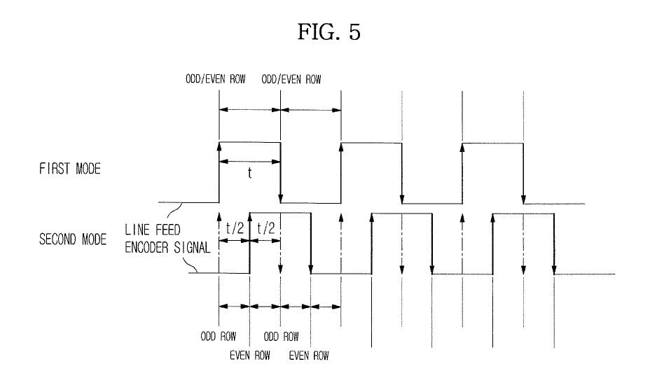

As illustrated in FIG. 5, in a case where the printing data is printed with a predetermined vertical resolution of, e.g., 1200 dpi, by use of the aforementioned head chips H, the printing data of one line can be printed according to the first mode and the second mode, such that each mode may have different printing timing. In a case of printing according to the first mode (full mode), the printing data of one line of the odd row of nozzles and the even row of nozzles are simultaneously printed to have a “real” vertical resolution of 1/1200 dpi. In a case of printing according to the second mode (half mode), the printing data of one line of the odd row of nozzles and the even row of nozzles are separated from each other, and are printed to have a “pseudo” double vertical resolution of 1/2400 dpi. In this case, because the printing data was originally generated to be 1200 dpi, the control unit 130 takes the same amount of time to generate the printing data of one line regardless of whether the full mode or half mode is being used. Therefore, the only difference between printing the printing data in the full mode or the half mode is that in the full mode the printing operation simultaneously prints the generated data of the odd and even rows of nozzles for a predetermined time “t”, and in the half mode the printing operation divides the generated data into the printing data of the odd row of nozzles and the data of the even row of nozzles and prints the printing data of the odd row of nozzles and the even row of nozzles for a predetermined time of “t/2”, thereby printing all of the printing data for the line for a combined time of “(t/2)*2)” which is equal to the predetermined time “t”. Referring to FIG. 5, in an embodiment of the present general inventive concept, printing timing may be adjusted by the control unit 130 in first mode printing such that odd and even row printing is performed simultaneously for the predetermined time “t”, and printing timing may be adjusted by the control unit 130 in second mode printing such that odd row and even row printing may each be performed separately for ½ the predetermined time “t”.

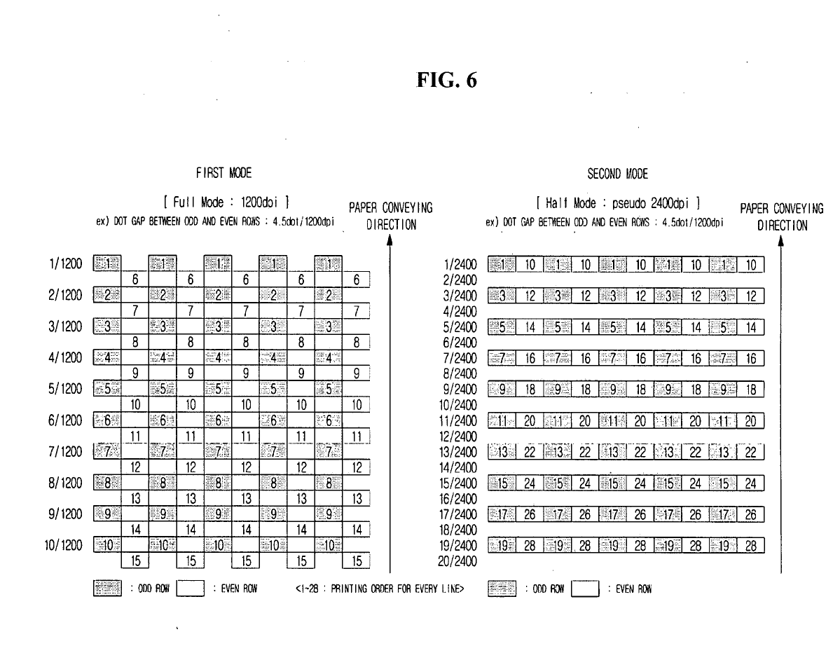

As illustrated in FIG. 6, when a gap formed between the odd row of nozzles and the even row of nozzles in the second and fourth head chips of FIG. 4 is within a predetermined tolerance (e.g., 5 dot/1200 dpi) and a gap formed between the odd row of nozzles and the even row of nozzles in the first and third head chips of FIG. 4 is beyond the predetermined tolerance (e.g., 4.5 dot/1200 dpi or 5.5 dot/1200 dpi), the printing data is printed according to user of the first mode (e.g., printed with 1200 dpi) and the second mode (e.g., printed with “pseudo” 2400 dpi). The results of the printing operation of this embodiment are illustrated in FIGS. 6 through 8.

As illustrated in FIG. 6, when the printing operation according to the first mode (full mode) is performed with respect to a head chip which has an erroneous gap, as described above, formed between the odd row of nozzles and the even row of nozzles (i.e., 4.5 dot/1200 dpi), only the printing data of the odd row of nozzles is sequentially printed on the first line (1/1200), the second line (2/1200), the third line (3/1200), the fourth line (4/1200) and the fifth line (5/1200) until the printing medium P is fed past a gap formed between the odd row of nozzles and the even row of nozzles. Then, the printing data of the odd row of nozzles is printed on the sixth line (6/1200), and at the same time, the printing data of the even row of nozzles is printed at a position on the printing medium P corresponding to the even row in the first line (1/1200). However, because the gap formed between the odd row of nozzles and the even row of nozzles is smaller than a normal gap formed by 0.5 dot printing, the printing data is printed at a position on the printing medium P below a normal position on the printing medium printed of 0.5 dot printing. Accordingly, line displacement is created. Such a phenomenon occurs identically on all lines.

When the printing operation according to the second mode is performed with respect to a head chip which has an erroneous gap formed between the odd row of nozzles and the even row of nozzles (4.5 dot/1200 dpi), only the printing data of the odd row of nozzles is sequentially printed on the first though ninth lines (1/2400-9/2400) until the printing medium P is fed past a gap (9/2400) formed between the odd row of nozzles and the even row of nozzles. Then, the printing data of the odd row of nozzles is printed on the tenth line (10/2400), and at the same time, the printing data of the even row of nozzles is printed at a position on the printing medium P corresponding to the even row in the first line (1/2400). In such a case, there is no printing data to be printed on the even lines.

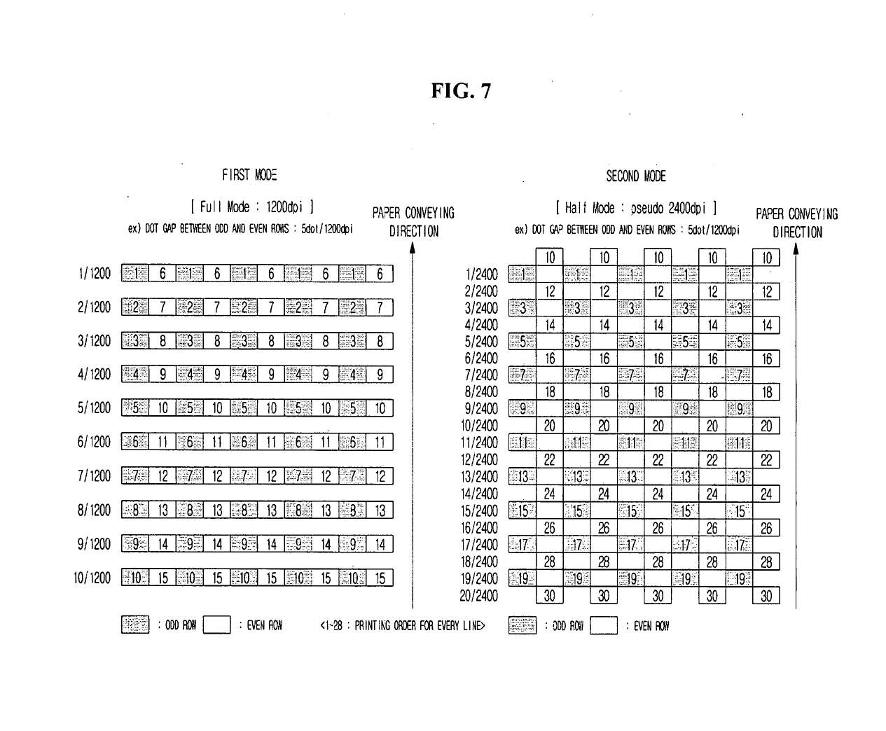

On the other hand, as illustrated in FIG. 7, when the printing operation according to the first mode is performed with respect to a head chip which has a normal gap formed between the odd row of nozzles and the even row of nozzles (5 dot/1200 dpi), line displacement does not occur. However, when the printing operation is performed according to the second mode, line displacement occurs.

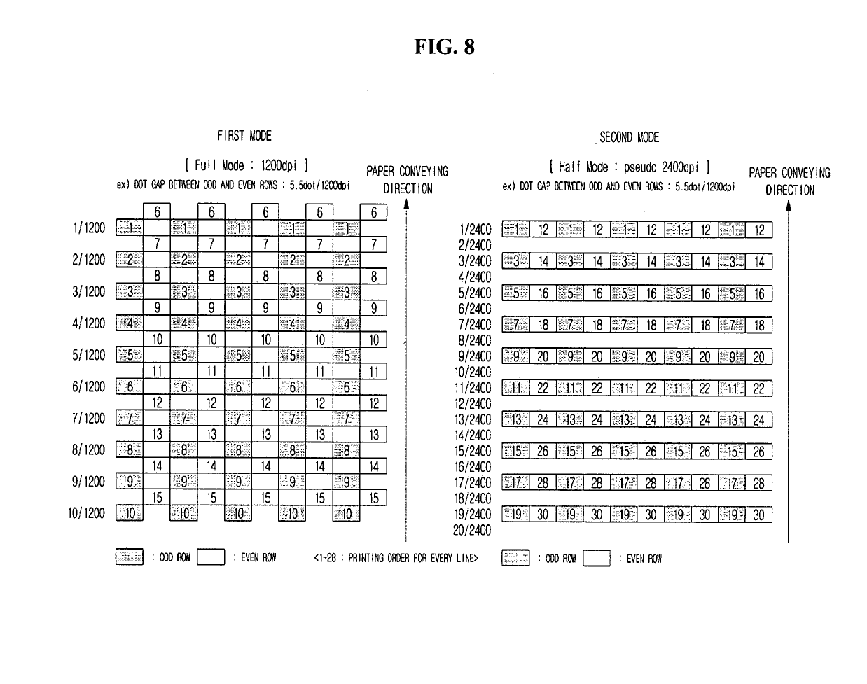

As illustrated in FIG. 8, when the printing operation according to the first mode is performed with respect to a head chip which has an erroneous gap formed between the odd row of nozzles and the even row of nozzles (5.5 dot/1200 dpi), because the gap formed between the odd row of nozzles and the even row of nozzles is larger than a normal gap formed by 0.5 dot printing, the printing data is printed at a position of the printing medium P above a normal position on the printing medium of 0.5 dot printing. Accordingly, line displacement occurs. When the printing operation is performed according to the second mode, line displacement does not occur.

Accordingly, in a case of the first mode printing operation, “4.5 dot/1200 dpi” printing is controlled by the controller 130 (referring to FIG. 1) to be equivalent to “5 dot/1200 dpi” printing, “5 dot/1200 dpi” printing is controlled by the controller 130 to perform “5 dot/1200 dpi” printing, and “5.5 dot/1200 dpi” printing is controlled by the controller 130 to be equivalent to “5 dot/1200 dpi” printing. Also, in a case of the second mode printing operation, “4.5 dot/1200 dpi” printing is controlled by the controller 130 to be equivalent to “pseudo 9 dot/2400 dpi” printing, “5 dot/1200 dpi” printing is controlled by the controller 130 to be equivalent to “pseudo 10 dot/2400 dpi”, and “5.5 dot/1200 dpi” printing is controlled by the controller 130 to be equivalent to “pseudo 11 dot/2400 dpi” printing.

As can be seen from the printing result illustrated in FIG. 6 to 8, when a gap formed between the odd row of nozzles and the even row of nozzles is in an integer multiple relationship having a basic resolution (e.g., 1″/1200), a printing error can be compensated for by adjusting printing timing in the first mode according to the gap formed between the odd row of nozzles and the even row of nozzles. However, when the gap formed between the odd row of nozzles and the even row of nozzles is not in an integer multiple relationship having a basic resolution (e.g., deviation of 0.5 dot), line displacement occurs between the odd row of nozzles and the even row of nozzles.

When a gap formed between the odd row of nozzles and the even row of nozzles is in an integer multiple relationship having a basic vertical resolution (e.g., 1″/1200), if the printing operation is performed according to the second mode, line displacement occurs between the odd row of nozzles and the even row of nozzles. However, when the gap formed between the odd row of nozzles and the even row of nozzles is not in an integer multiple relationship having a basic vertical resolution (e.g., deviation of 0.5 dot), a printing error can be compensated by adjusting printing timing in the second mode according to the gap formed between the odd row of nozzles and the even row of nozzles.

Accordingly, when the print head includes, for example, four head chips, two of which have a normal formed gap and two of which have an erroneous formed gap which deviates from a normal value of 5.0 dot by +0.5 dot, line displacement between the odd row of nozzles and the even row of nozzles can be prevented by controlling every head chip according to the adequately selected first mode or second mode.

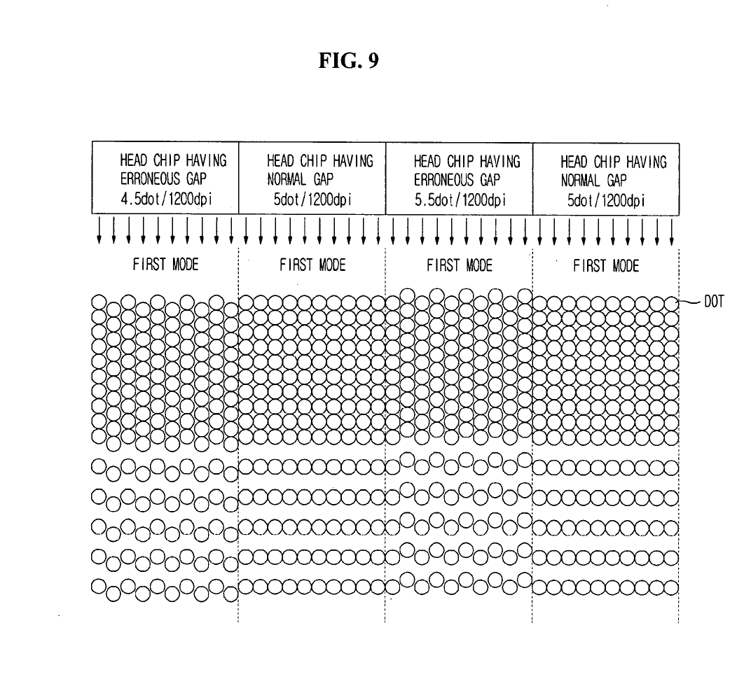

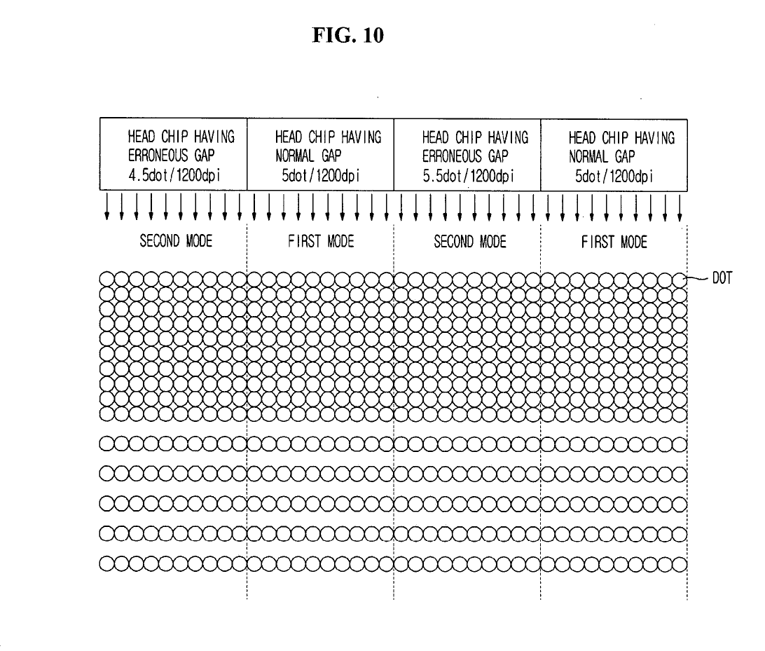

FIG. 9 illustrates a printing result when performing the printing operation according to only the first mode with respect to both the head chips having a normal formed gap and the head chips having an erroneous formed gap. FIG. 10 illustrates a printing result when performing the printing operation according to the first mode with respect to the head chips having a normal formed gap and performing the printing operation according to the second mode with respect to the head chips having an erroneous formed gap.

As illustrated in FIG. 9, if the printing operation is performed according to the first mode (which is a conventional printing method) with respect to the head chips having an erroneous formed gap, severe deterioration of image quality may occur. According to the present general inventive concept, as illustrated in FIG. 10, if the first mode or the second mode is selected adequately for a gap formed between the odd row of nozzles and the even row of nozzles, and the head chips are controlled by the selected control mode, deterioration of image quality can be minimized.

The present general inventive concept can also be applied to a high resolution (e.g., 2400 dpi, 4800 dpi, etc.) printing operation, to minimize deterioration of image quality due to line displacement.

As is apparent from the above description, the inkjet image forming apparatus according to the present general inventive concept can prevent line displacement in an outputted image on a printing medium and accordingly can minimize deterioration of image quality, in such a manner that the head chips having a normal formed gap (which is in an integer multiple relationship having a resolution of, e.g., 9″/1200 or 10″/1200) are controlled according to the first mode, by which the printing data of the odd and even rows of nozzles for every line are simultaneously printed to have a basic vertical resolution, and the head chips having an erroneous formed gap (which is not in an integer multiple relationship having a resolution of, e.g., 8.5″/1200 or 9.5″/1200) are controlled according to the second mode, such that the printing data of the odd row of nozzles and the printing data of the even row of nozzles for every line are alternately printed to have a double basic vertical resolution.

Although a few embodiments of the present general inventive concept have been illustrate and described, it would be appreciated by those skilled in the art that changes may be made in these embodiments without departing from the principles and spirit of the general inventive concept, the scope of which is defined in the appended claims and their equivalents.

What is claimed is:

1. An inkjet image forming apparatus, comprising:
a print head including a plurality of head chips each having nozzles arranged in a plurality of rows such that at least two rows are associated with a single color;
a storage unit to store position information of a head chip having a normal gap formed between a first row of nozzles and a second row of nozzles of the at least two rows of nozzles, position information of the head chip having an erroneous gap formed between the first row of nozzles and the second row of nozzles, and gap information of the print head; and
a control unit to control the head chip having the normal gap according to a first mode such that printing data of the first row of nozzles and the second row of nozzles of each line of printing data are simultaneously printed to have a basic vertical resolution, and to control the head chip having the erroneous gap according to a second mode such that the printing data of the first row of nozzles and the second row of nozzles for each line of printing data are alternately printed to have a double basic vertical resolution.

2. The inkjet image forming apparatus according to claim 1, wherein when the gap formed between the first row of nozzles and the second row of nozzles is deviated from an integer multiple of a normal gap by ½ dot, the control unit controls the head chip according to the second mode.

3. The inkjet image forming apparatus according to claim 1, wherein the plurality of head chips are arranged in a zigzag pattern.

4. The inkjet image forming apparatus according to claim 3, wherein the first row of nozzles and the second row of nozzles of each of the plurality of head chips are arranged in a zigzag pattern.

5. The inkjet image forming apparatus according to claim 4, wherein the nozzles of each of the plurality of head chips are arranged to include at least two rows for each color of cyan, magenta, yellow and black.

6. An inkjet image forming apparatus, comprising:
a print head including a plurality of head chips each having nozzles arranged in two rows for each of a plurality of colors;
a storage unit to store position information of a head chip having a normal gap formed between a first row of nozzles and a second row of nozzles of the two rows of nozzles, position information of a head chip having an erroneous gap formed between the first row of nozzles and the second row of nozzles, and gap information of the print head; and
a control unit to control the head chip having the normal gap according to a first mode such that printing data of the first row of nozzles and the second row of nozzles for each line of printing data are simultaneously printed to have a basic vertical resolution, and to control the head chip having the erroneous gap selectively according to the first mode or according to a second mode such that the printing data of the first row of nozzles and the second row of nozzles for each line of printing data are alternately printed to have a double basic vertical resolution depending on the gap formed between the first row of nozzles and the second row of nozzles.

7. The inkjet image forming apparatus according to claim 6, wherein when the gap formed between the first row of nozzles and the second row of nozzles is in an integer multiple relationship with the normal gap, the control unit controls the head chip according to the first mode by adjusting printing timing of the first row of nozzles and the second row of nozzles.

8. The inkjet image forming apparatus according to claim 6, wherein when the gap formed between the first row of nozzles and the second row of nozzles is deviated from an integer multiple of a normal formed gap by ½ dot, the control unit controls the head chip according to the second mode.

9. The inkjet image forming apparatus according to claim 6, wherein the plurality of head chips are arranged in a zigzag pattern.

10. The inkjet image forming apparatus according to claim 9, wherein the first row of nozzles and the second row of nozzles of each of the plurality of head chips are arranged in a zigzag pattern.

11. The inkjet image forming apparatus according to claim 10, wherein the nozzles of each of the plurality of head chips are arranged to include two rows for each color of cyan, magenta, yellow and black.

12. An inkjet image forming device, comprising:
a plurality of printing medium conveying parts to convey a printing medium;
a print head including a plurality of head chips each having a plurality of rows of nozzles to print an image on the printing medium; and
a control unit to receive from an external device position information of a head chip of the print head having a normal gap formed between two adjacent rows of at least one of the plurality of head chips and of a head chip of the print head having an erroneous gap formed between the two adjacent rows of at least one of the plurality of head chips, and to control the head chip having the normal formed gap and the head chip having the erroneous formed gap to perform a printing operation in a first mode for the head chip having the normal formed gap and in a second mode for the head chip having the erroneous formed gap by adjusting the printing timing of the two adjacent rows of nozzles.

13. The inkjet image forming device according to claim 12, wherein the first mode is full mode printing and the second mode is half mode printing.

14. The inkjet image forming device according to claim 12, wherein in the printing operation of the second mode each of the two adjacent rows of nozzles is printed for a time substantially equal to one-half of a time for printing for each of the two adjacent rows printed in the printing operation of the first mode.

15. A method to control an inkjet image forming apparatus having a print head having a plurality of head chips, the method comprising:
storing position information of the plurality of head chips;
controlling at least one head chip which includes a normal gap formed between adjacent rows of nozzles of the at least one head chip to print printing data in the adjacent rows of nozzles simultaneously for a first time duration; and
controlling at least one head chip which includes an erroneous gap formed between adjacent rows of nozzles of the at least one head chip to print printing data in the adjacent rows of nozzles such that a first of the adjacent rows of nozzles is controlled to print printing data for a second time duration equal to one-half the first time duration and a second of the adjacent rows of nozzles is controlled to print printing data for the second time duration but not simultaneously with the printing of the printing data by the first of the adjacent rows of nozzles.

16. The method according to claim 15, wherein the erroneous gap is formed between the adjacent rows of nozzles such that the gap deviates by approximately ±0.5 dot from a normal formed gap.
